(19) United States
(12) Patent Application Publication
(10) Pub. No.: US 2007/0157877 A1
(43) Pub. Date: Jul. 12, 2007

(54) Moist/ medicated/ scented toilet paper dispenser

(75) Inventor: William Delbert Barnes III, North Hollywood, CA (US)

Correspondence Address: William Delbert Barnes III, 5121 Klump Ave. #212, North Hollywood, CA, 91601, US

(73) Assignee: William Delbert Barnes III, North Hollywood, CA (US)

(21) Appl. No.: 11/649,059

(22) Filed: Jan. 3, 2007

(51) Int. Cl. B05C 5/00

(52) U.S. Cl. 118/325

(57) ABSTRACT

My invention will simply replace the standard toilet paper roll that is commonly used in bathrooms throughout the United States and abroad. It will be directly attached to the standard toilet paper holder installed in most homes. Once attached to the standard toilet paper holder, the consumer may then use the contents of the dispenser which will contain either moist, medicated, or moisturized toilet paper sheets. The product will meet the consumers needs hence the amount of aging baby boomers which will populate the United States and abroad in the next five to ten years.

### CROSS REFERENCES TO RELATED APPLICATIONS

NA

### BACKGROUND OF THE INVENTION

A toilet paper dispenser designed to fit on the standard toilet paper holder commonly installed in most households. This product was designed and intended to be used on a standard toilet paper holder using the standard rod/axle which will go through the carton which houses the various types of paper that will be packaged in a plastic pouch that will hold moisture upon removing foil seal on product. The paper held within such package will be lightly medicated/moisturized/scented to meet the needs of today's marketplace. Up till now there has not been such a product on the market. With the increasing number of individuals with eating disorders and hemorrhoids, this product will be very pleasing to our baby boomers, and will conveniently be installed in place of your ordinary toilet paper roll.

### SUMMARY OF THE INVENTION

Being able to use a moist/medicated/scented toilet tissue for their hemorrhoids without special application on a regular basis, giving the consumer the ultimate freedom without the constant need for certain ointments and creams.

### BRIEF DESCRIPTION OF FIGURES/DRAWINGS

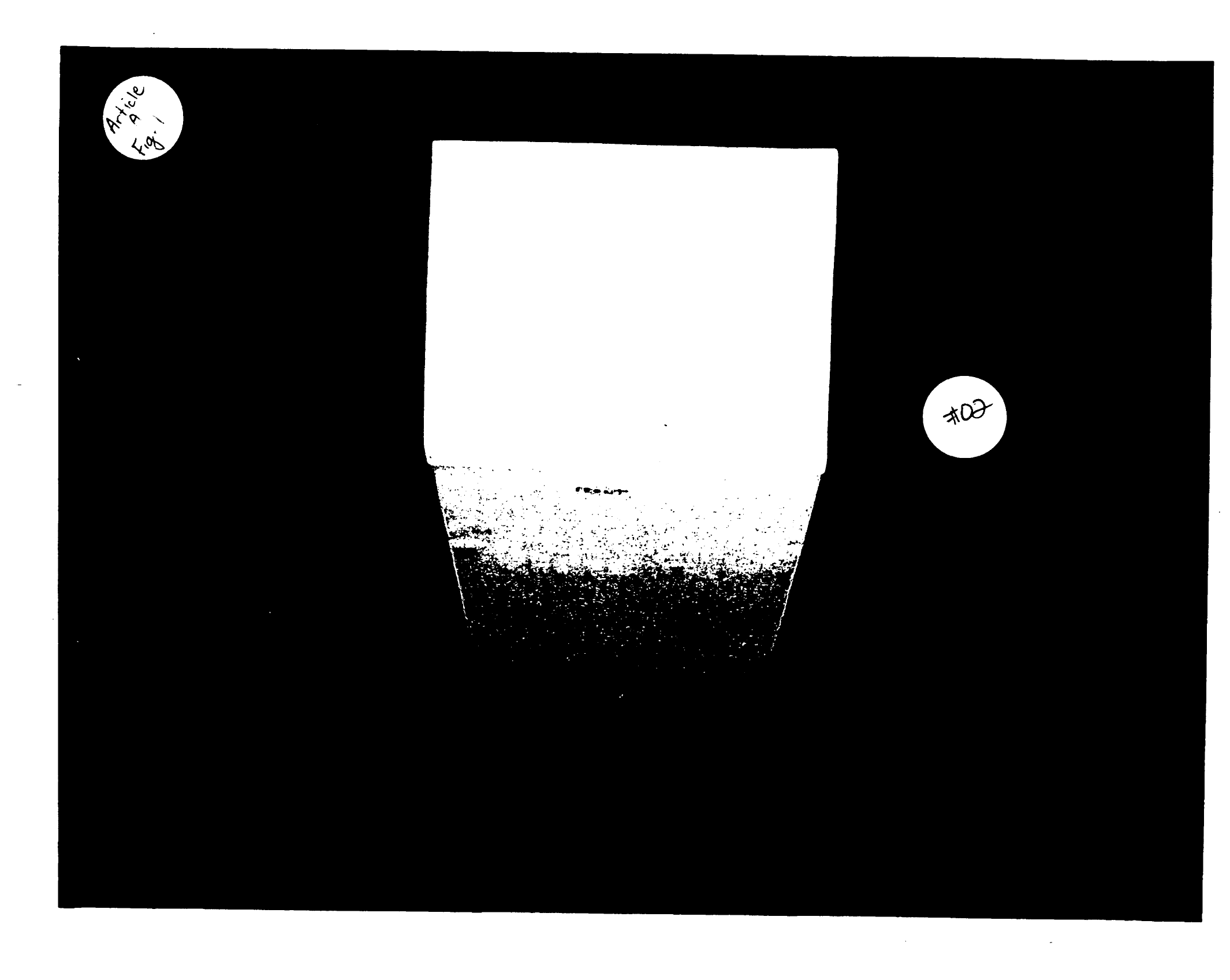

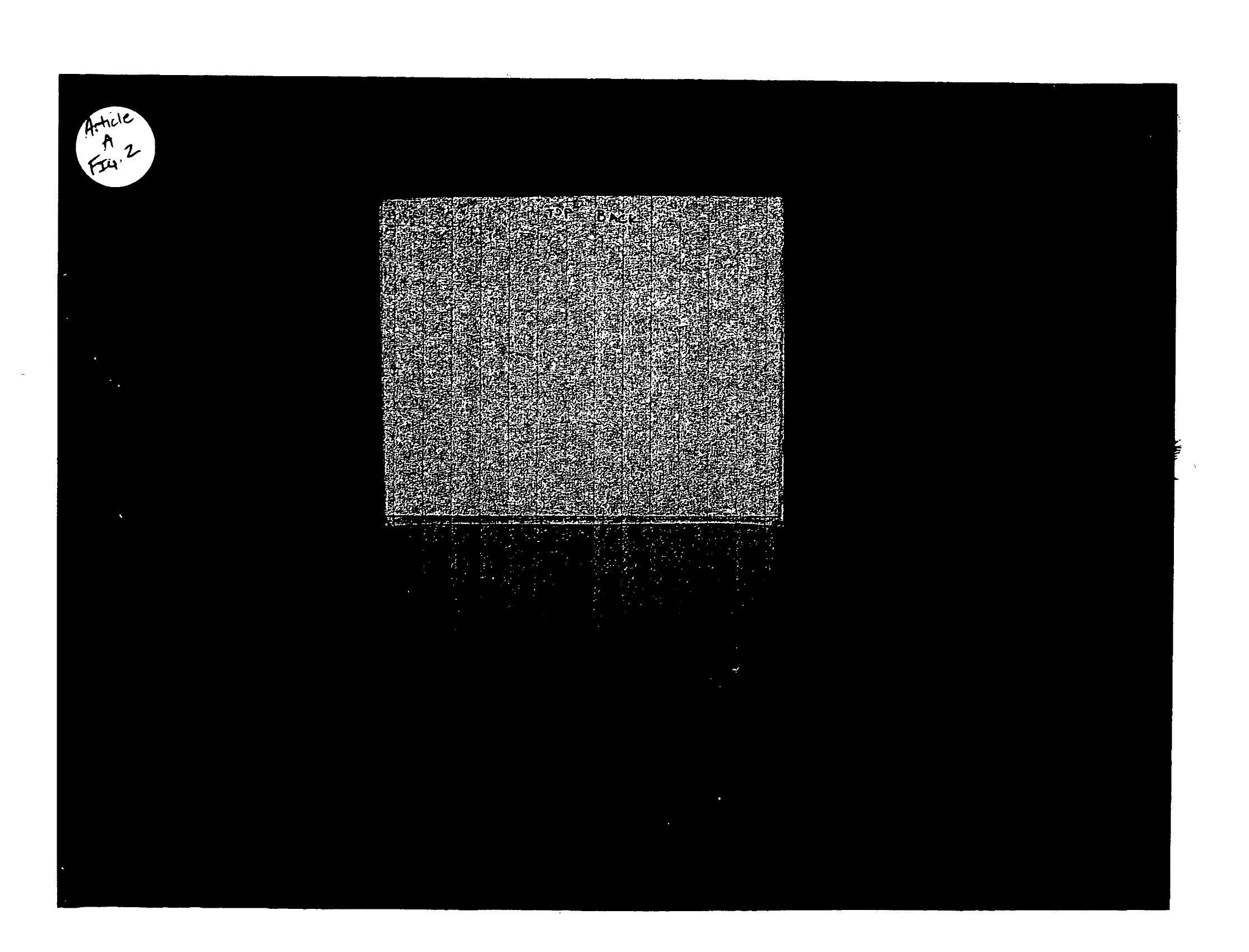

ARTICLE A FIG. 1: Elevated view of the top frontal section of the invention. Section of photo with the bold diagonal lines will be cut out and has no part of the invention.

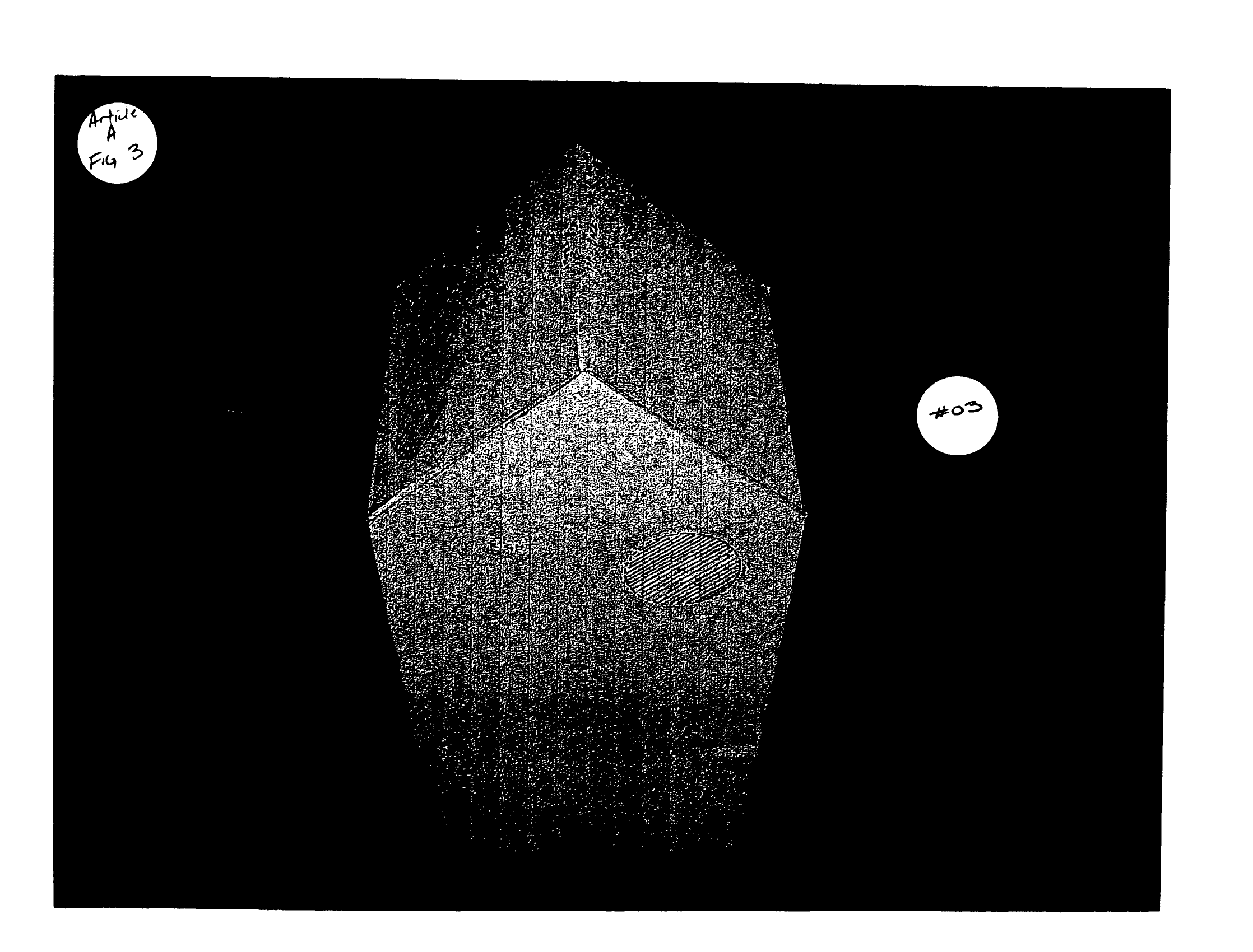

ARTICLE A FIG. 2: Elevated view of the back top section of the invention.

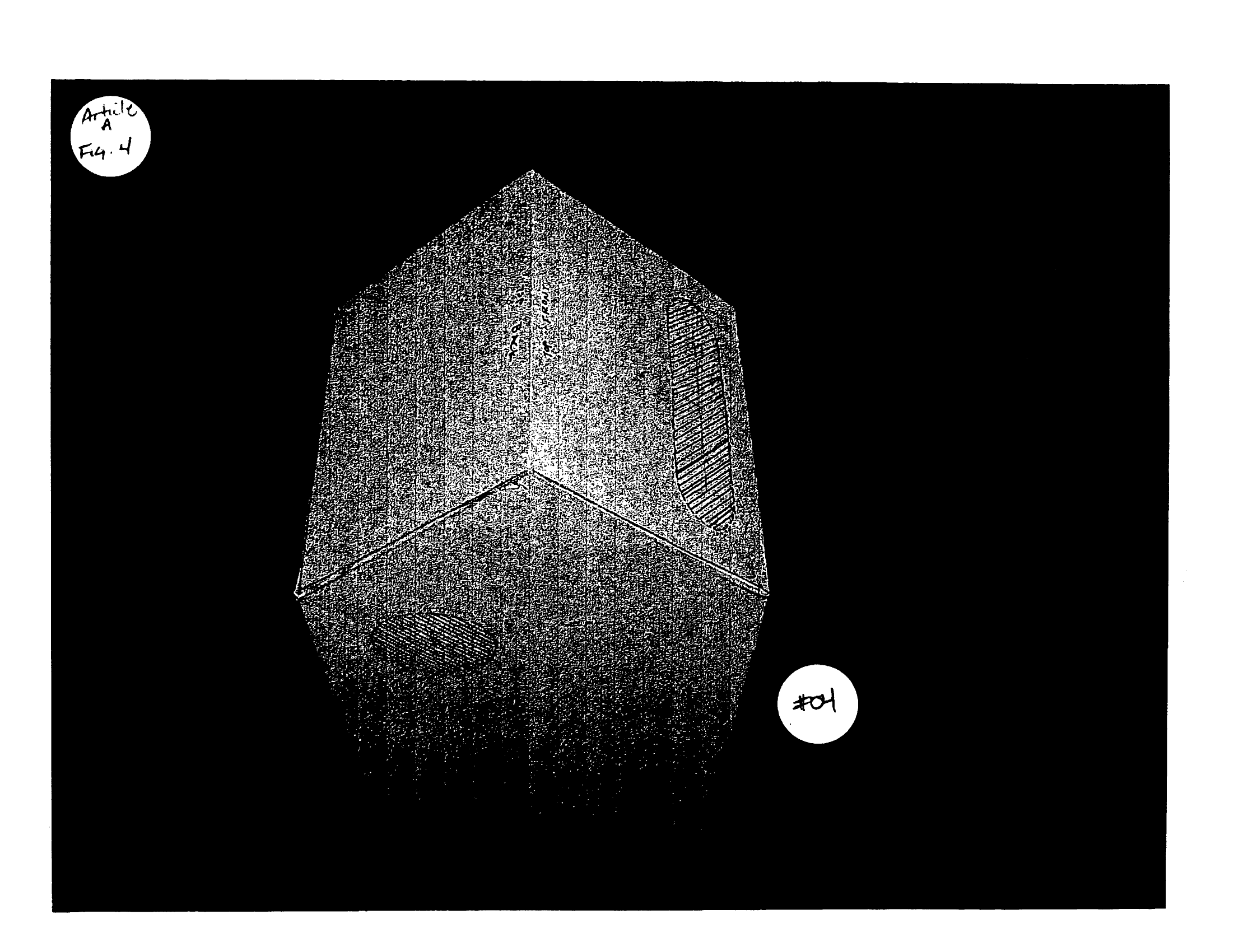

ARTICLE A FIG. 3: Elevated view of the top right section of the invention. Sections of photo with the bold diagonal lines will be cut out. Standard toilet paper rod will go through round cut out all the way through to cut out on opposite side (not seen in this photo).

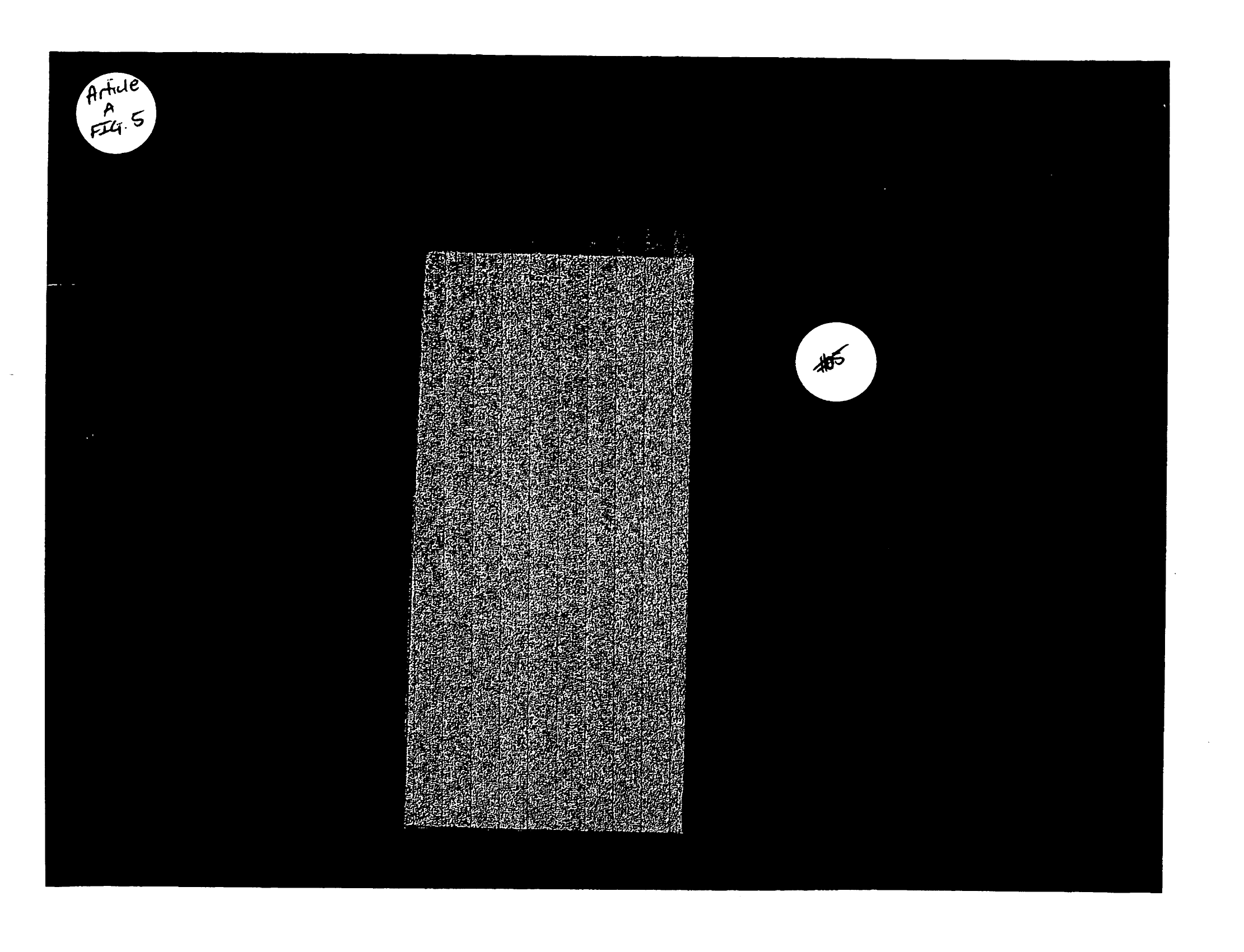

ARTICLE A FIG. 4: Elevated view of the top left section of the invention. Sections of photo with the bold diagonal lines will be cut out. Standard toilet paper rod will go through round cut out all the way through to cut out on opposite side (not seen in this photo).

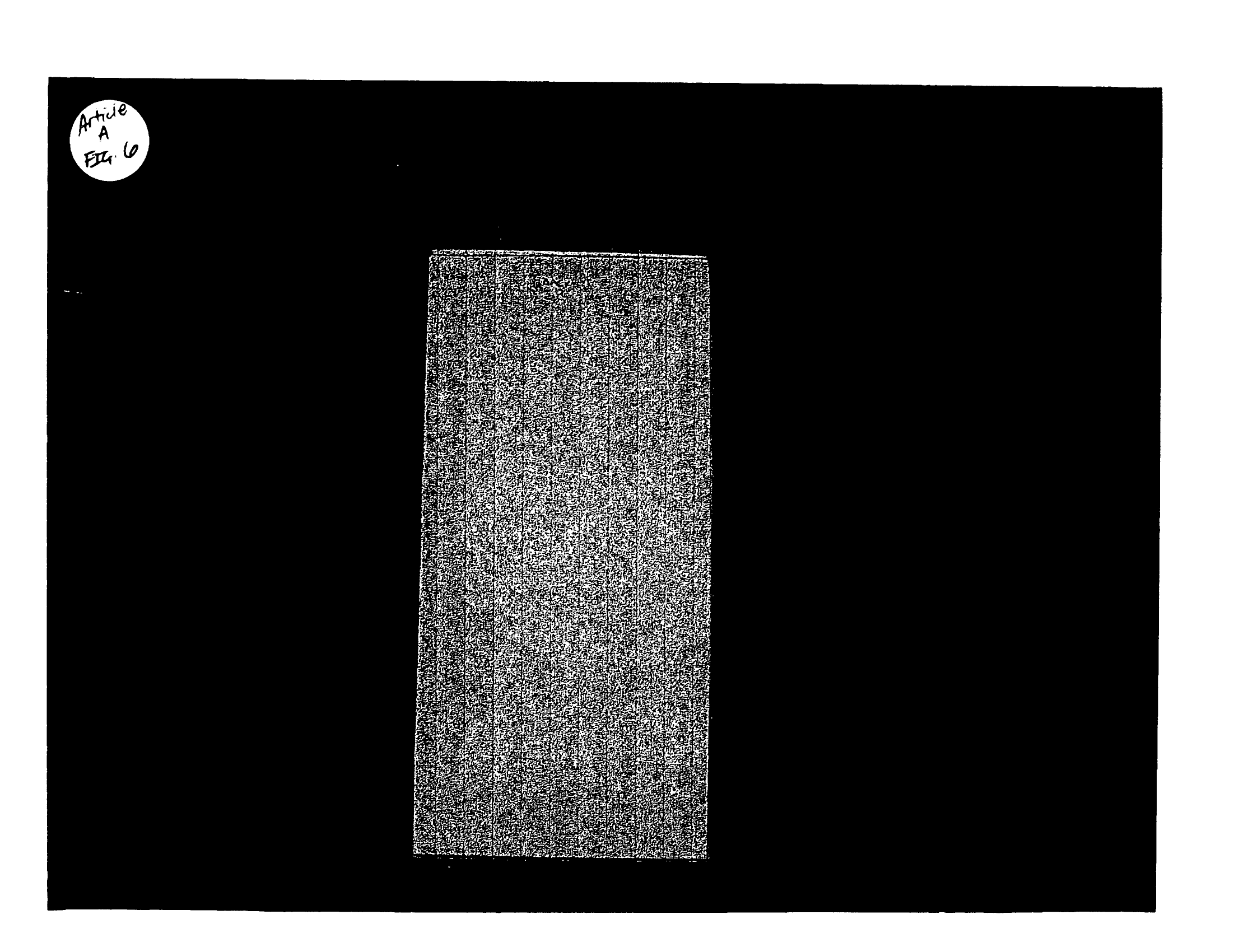

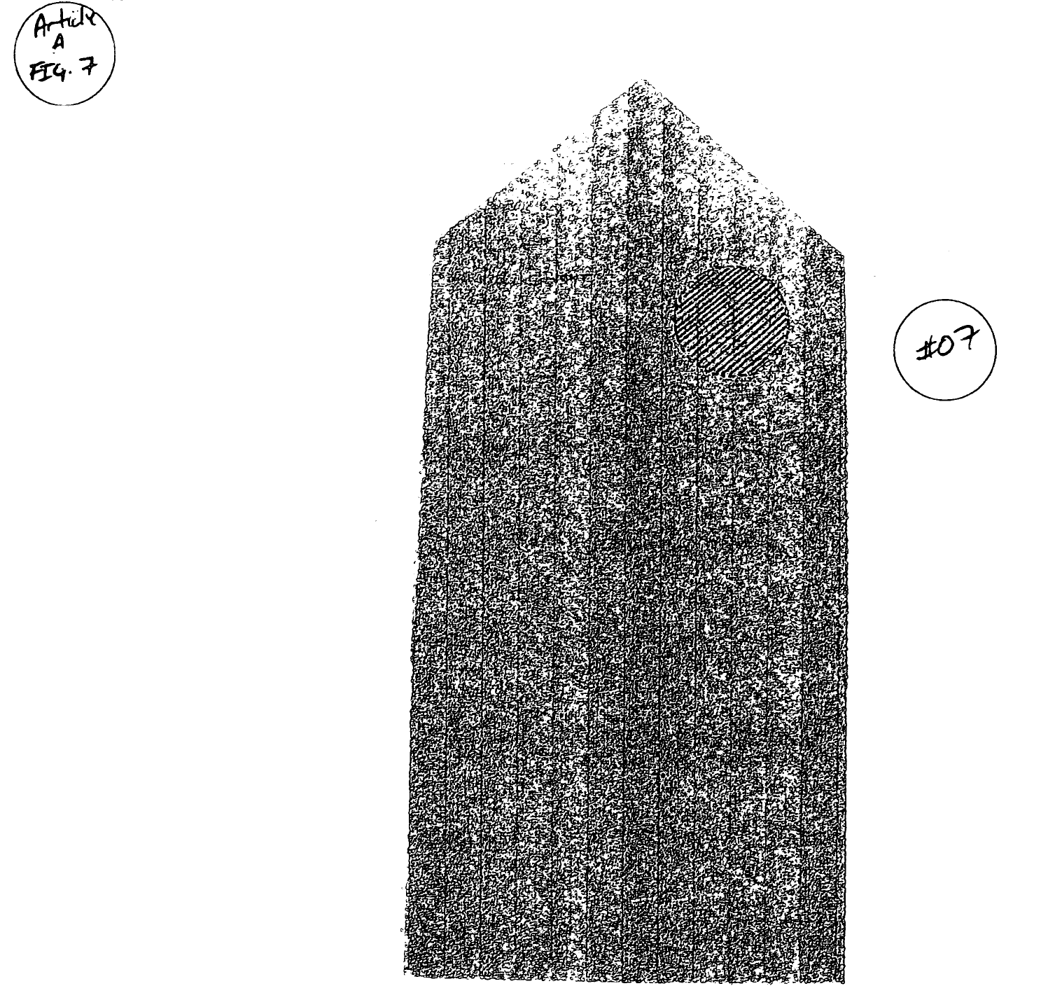

ARTICLE A FIG. 5: Flat view of front side of invention. Section of photo with the bold diagonal lines will be cut out and has no part of the invention.

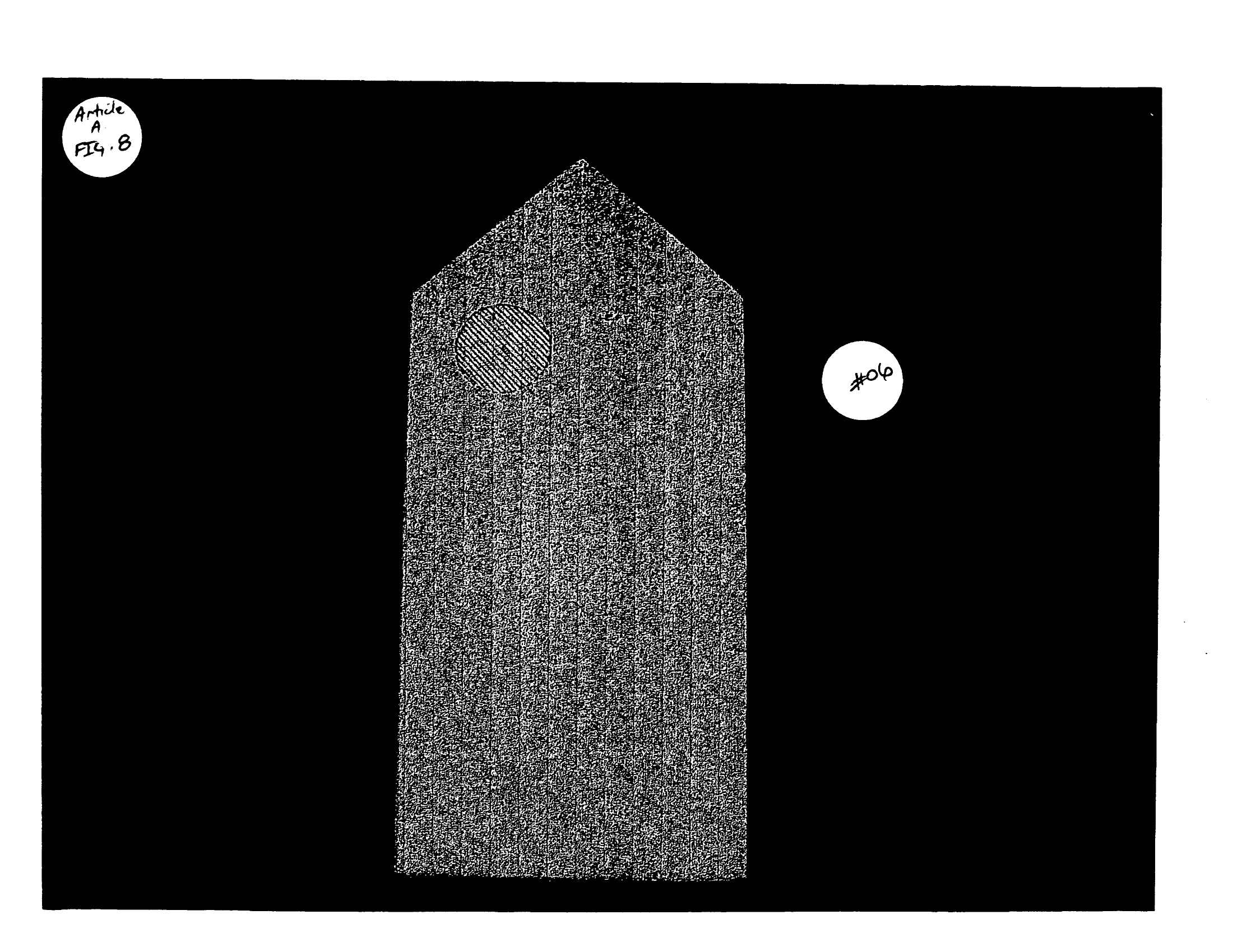

ARTICLE A FIG. 6: Flat view of back side of invention.

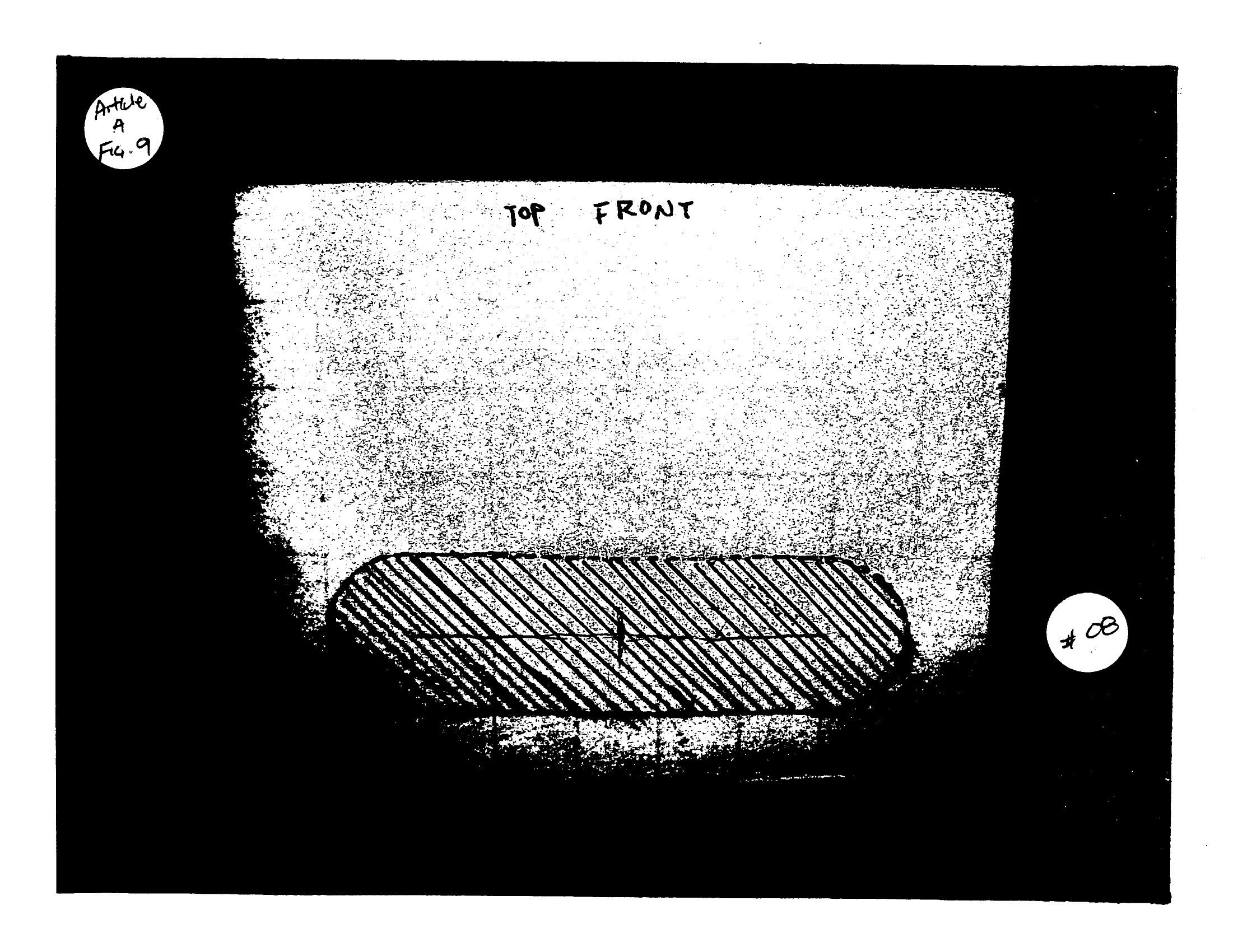

ARTICLE A FIG. 7: Flat view of right side of invention. Bold diagonal lines indicate section which will be cut out and has no part of the invention.

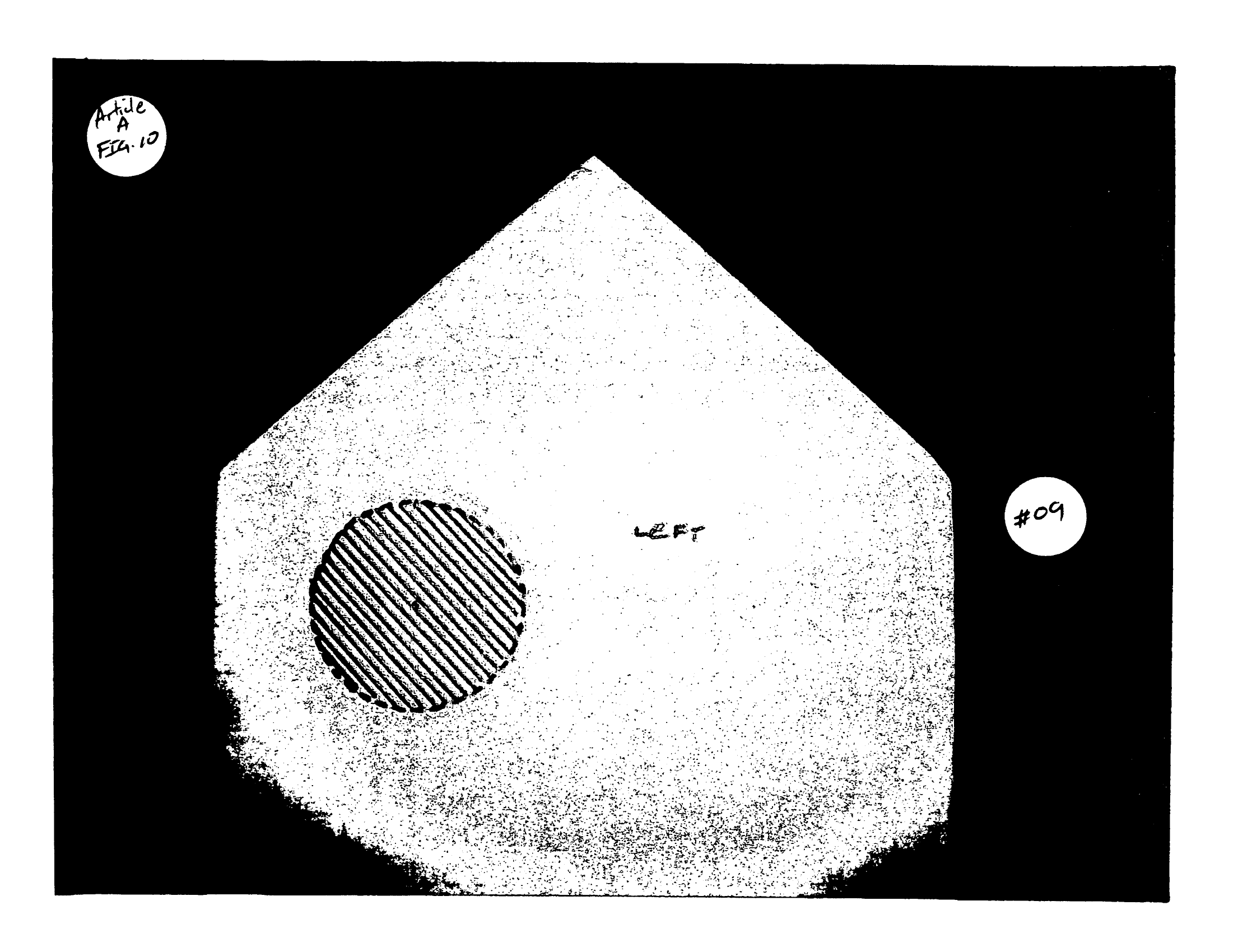

ARTICLE A FIG. 8: Flat view of left side of invention. Bold diagonal lines indicate section which will be cut out and has no part of the invention.

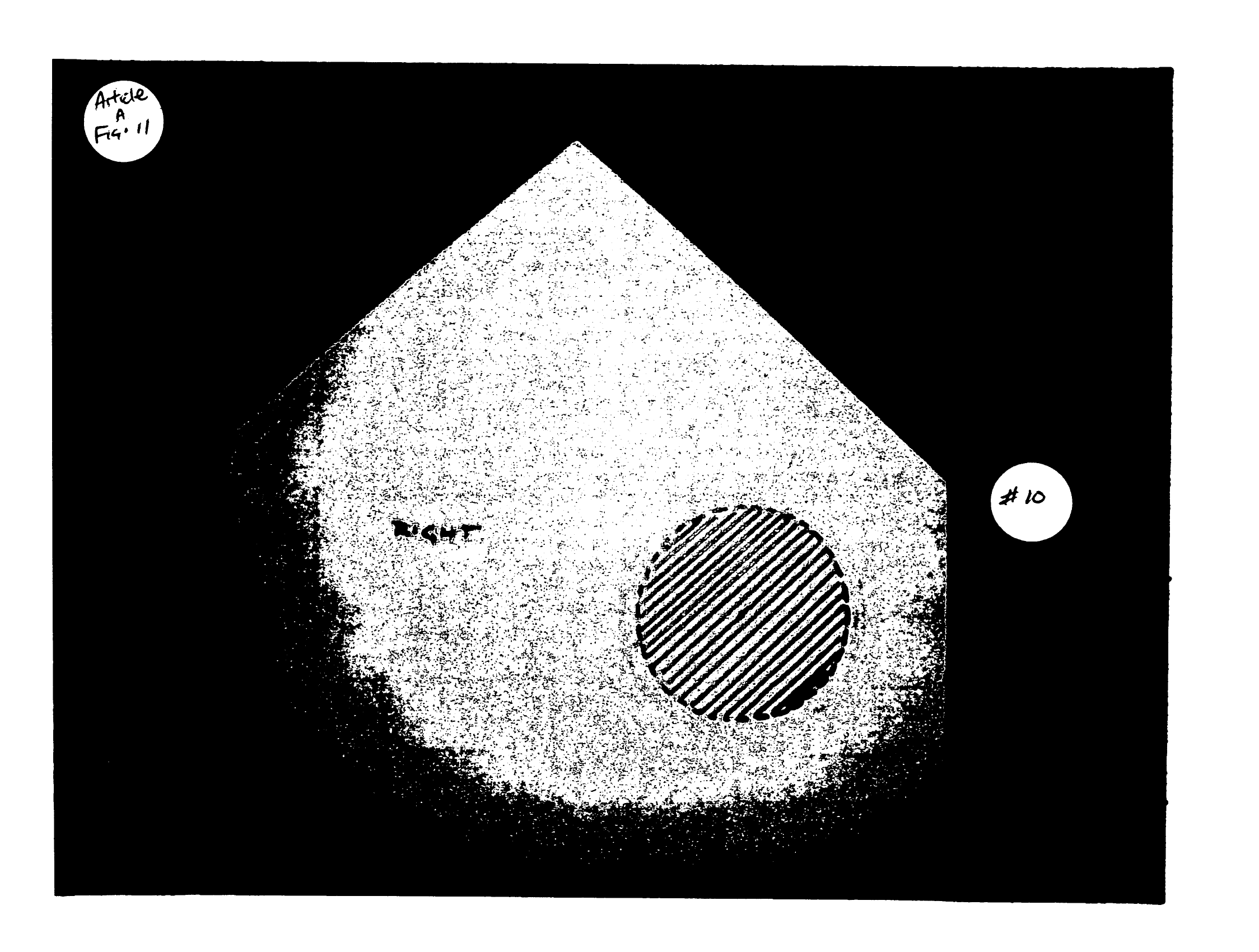

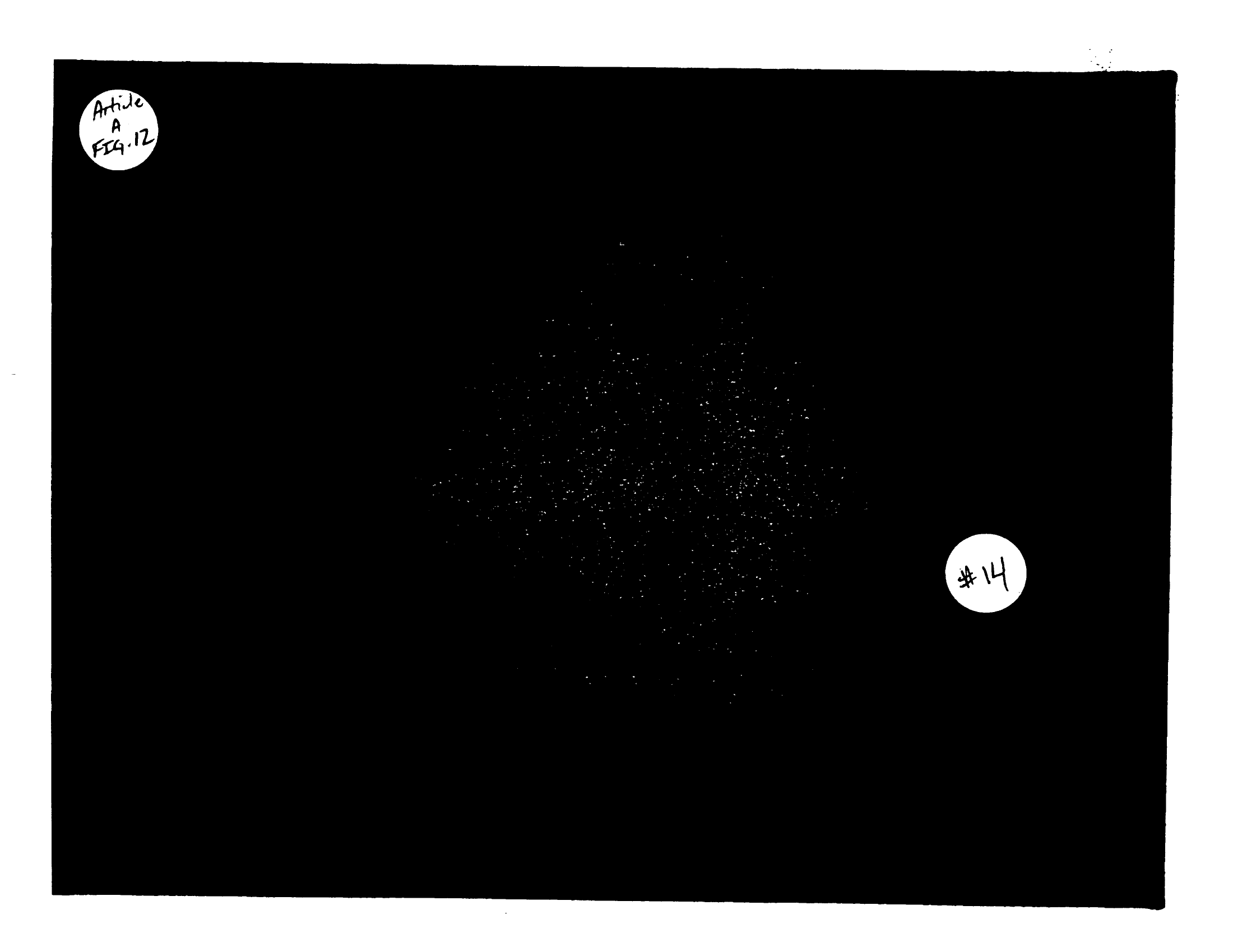

ARTICLE A FIG. 9: Close up of top front section of the invention. Bold diagonal lines indicate section which will be cut out and has no part of the invention.

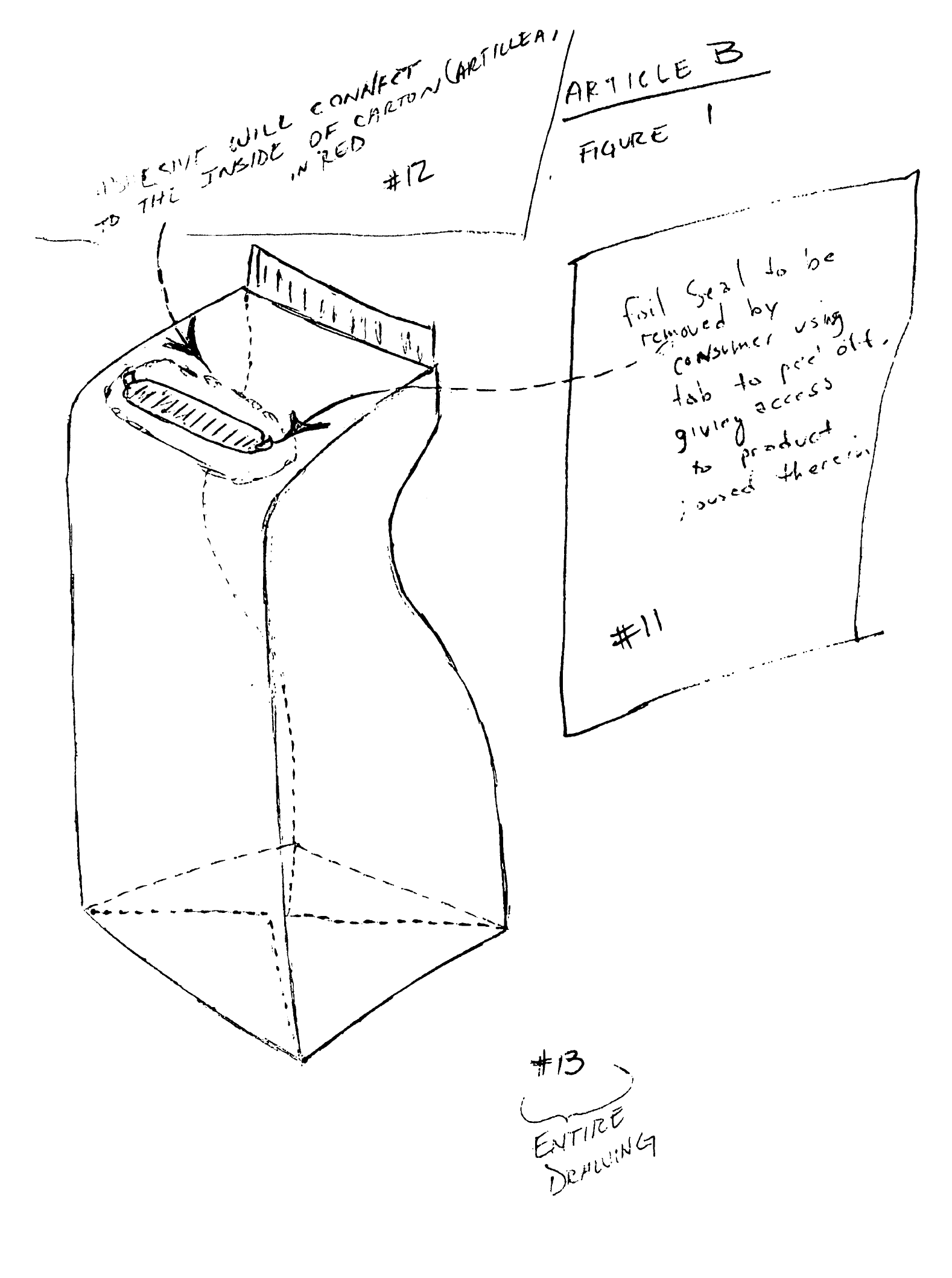

ARTICLE A FIG. 10: Close up of top left section of the invention. Bold diagonal lines indicate section which will be cut out and has no part of the invention.

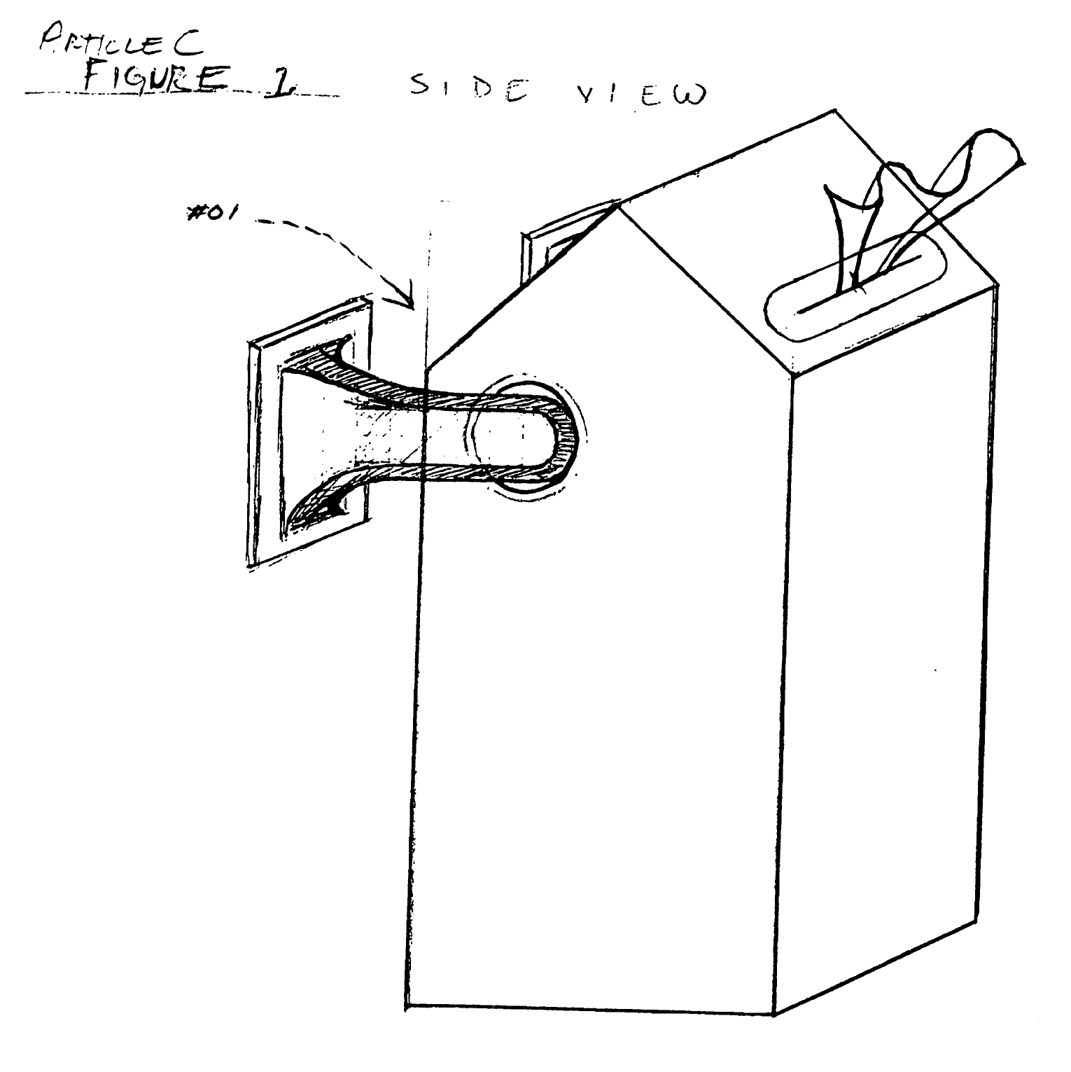

ARTICLE A FIG. 11: Close up of top right section of the invention. Bold diagonal lines indicate section which will be cut out and has no part of the invention.

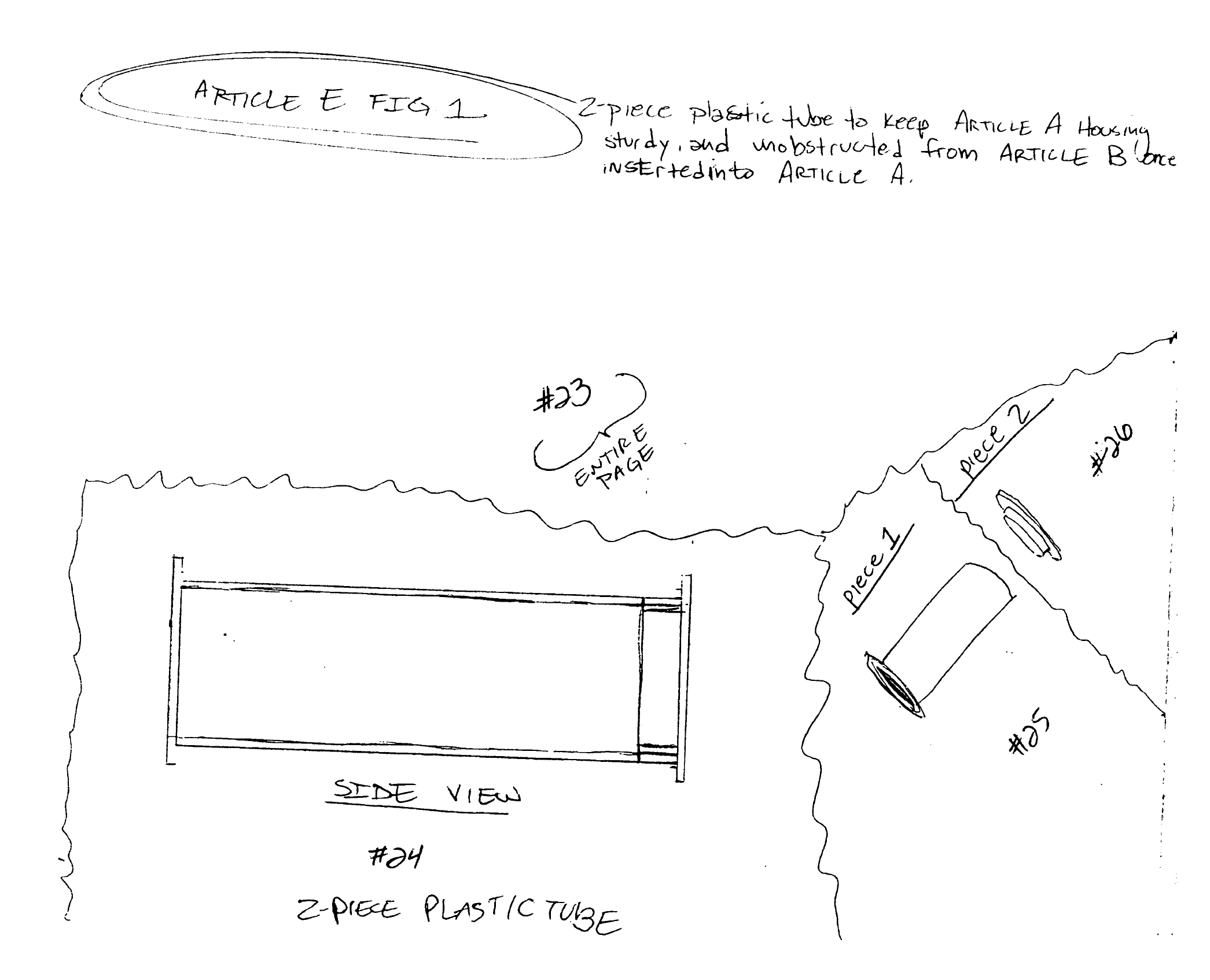

ARTICLE A FIG. 12: Close up of bottom section of the invention.

ARTICLE B FIG. 1: Depicts the appearance of the packaging holding paper product which will be held internally in Article A completing the invention

ARTICLE C FIG. 1: This is how the invention will look installed on standard bathroom toilet paper fixture

ARTICLE D FIG. 1: This shows a full scale drawing of the schematic which adequately shows the proper measurements which will be used to formulate the housing of the product in the manufacturing process.

ARTICLE E FIG. 1: Shows 2 piece plastic tube which will be inserted through circular openings shown on Article A FIGS. 3 & 4, 7 & 8, and 10 & 11

### DETAILED DESCRIPTION OF THE PREFERRED EMBODIMENT:

The usage of my invention will be simply to replace the common household toilet paper with a product that is more user friendly, especially to the baby boomer market. The invention will be able to be installed on the common toilet paper roll fixture located in most bathrooms worldwide. My product was designed to fit all such fixtures. As seen in Article C FIG. 1 labeled with numeral #01 gives an adequate idea of how the product will look installed on its intended household fixture, but may also be used on your common counter top. Article A FIG. 1 labeled with numeral #02 shows where the product therein will exit from (section with diagonal lines, which will be cut out). From another angle as seen in flat front view on Article A FIG. 5 labeled with numeral #05, the same exit point from different perspective (section with diagonal lines, which will be cut out). Close ups describing the above mentioned exit point may be seen on Article A FIG. 9 labeled with numeral #08 (section with diagonal lines, which will be cut out).

In the next description, you will see how the invention will be connected to the preferred common bathroom toilet roll fixture, hence using common toilet paper rod/axle. Article A FIG. 3 labeled accordingly with numeral #03 shows the circular entry/exit point at which the common toilet tissue rod/axle will go through (circular section with diagonal lines, will be cut out). Article A FIG. 4 labeled with numeral #04 shows a view of the reverse side which also shows an identical circular pattern at which the common toilet tissue rod/axle will also enter/exit from (circular section with diagonal lines, will be cut out). A flat view of the above mentioned circular patterns may also be viewed in Article A FIGS. 7 & 8 labeled with numerals #06 & #07 (again, circular sections with diagonal lines will be cut out). Close-ups of the circular patterns may also be viewed on Article A FIGS. 10 & 11 labeled accordingly with numerals #09 & #10 (circular sections with diagonal lines will be cut out).

In the next paragraph a description of the internal portion of Article A will be described herein. Article B FIG. 1 appropriately labeled with numeral #13 shows how the packaging held within Article A will look like. In the drawing of Article B FIG. 1 labeled with numeral #11 you will see an arrow pointing to a foil seal that will keep the contents moist prior to opening package. The foil seal may be removed easily by pulling on a tab located on either side of the seal. In the drawing of Article B FIG. 1 labeled with numeral #12, shows where an adhesive/glue will be applied in the manufacturing process prior to sealing the bottom of Article A, shown in Article A FIG. 12 labeled with numeral #14.

In this paragraph a description of the schematic shown in Article D FIG. 1 labeled with numeral #15 will be described herein. Here on this drawing (Article D FIG. 1), it will give you all the measurements to fabricate the carton which houses Article B FIG. 1. To Fabricate Article A the preferred material used will be wax coated on one side; the other side will have product logos, name, instructions, label etc . . . Step one would be to cut out the circular and pill shaped designs shown in red and outlined with red broken lines, and along the entire outer lines shown in Article D FIG. 1. Once everything has been cut out, the next step would be to press all solid lines shown on schematic with proper machinery. Once all sections with solid lines on schematic have been pressed by machine, it will then be ready to fold accordingly by machine process.

Here are step by step instructions to fabricate the outer packaging expressed in Article C FIG. 1 and Article A FIGS. 1 through 12.

### EVERY STEP HEREAFTER TAKES PLACE IN CORRELATION TO ARTICLE D FIG. 1

1. All sections labeled with the word tab, will be folded upward at a 90 degree angle.
2. Section labeled with #16 will be folded upward at a 90 degree angle.
3. Section labeled with #18 will be folded upward and adhered with carton grade adhesive to tab 2.
4. Section labeled with #19 will be folded downward and adhered to tab 1.
5. Next section labeled #20 will be folded upward at a 90 degree angle, then tab 4 will be adhered with carton grade adhesive to section labeled #18 and tab 5 will be adhered with carton grade adhesive to section labeled #19.
6. Section labeled #21 will be folded inward at a 90 degree angle, then adhered with carton grade adhesive to tab 9 leaving bottom section opened.
7. Now with bottom section opened, insert Article E FIG. 1 numeral #25 in through Article D FIG. 1 numeral #27 and out through Article D FIG. 1 numeral #28. Then glue will be added to the inside of Article E FIG. 1 numeral #26 and inserted to the end of numeral #25 shown on Article E FIG. 1 numeral #23
8. With bottom remaining opened Article B FIG. 1 which houses the moist/medicated/scented high absorbency toilet tissue may now be inserted with adhesive shown on drawing Article B FIG. 1 numeral #12, to section #18, with foil seal in plain view through opening on #18.
9. Now section #22 may now be folded over and adhered with carton grade adhesive to tabs 6, 7 & 8.
   Complete and ready to be boned and shipped to distribution center.

1. William D. Barnes III, Independent Inventor, claim the intellectual property rights of the items shown in Articles A, B, C, D, and E and the product intended for the public use (excluding the common household toilet paper roll fixture that the product will be installed upon shown in Article C FIG. 1)
